(19) United States
(12) Patent Application Publication
(10) Pub. No.: US 2003/0046422 A1
(43) Pub. Date: Mar. 6, 2003

(54) Object-oriented routing

(76) Inventors: Ravi Narayanan, Plano, TX (US); Richard Patchet, Allen, TX (US); Peter Brockmann, Allen, TX (US)

Correspondence Address: Ortiz & Lopez, PLLC, Suite 300, 4054 McKinney Avenue, Dallas, TX, 75204, US

(21) Appl. No.: 10/083,319

(22) Filed: Oct. 19, 2001

Related U.S. Application Data
(60) Provisional application No. 60/317,027, filed on Sep. 4, 2001.

(51) Int. Cl. G06F 15/173; G06F 9/44

(52) U.S. Cl. 709/238; 709/315

(57) ABSTRACT

Object-oriented routing specifies a method and system for routing objects over a network. An object, which comprises a self-contained module of data and associated processing information (i.e., software method), can be designated and thereafter routed over the distributed computer network utilizing an object router, which can parse the object and apply the associated processing information contained with the object thereby permitting the object router to be self-programmable for any data format. The object router thus comprises an object-oriented router. The object router is permitted to construct the object by dynamically downloading the associated processing information corresponding to data received from an external data source.

### CROSS REFERENCE TO RELATED PATENT APPLICATION

This patent application is related to provisional patent application, “Process Router Method and System,” Serial No. 60/317,027, which was filed on Sep. 4, 2001. This patent application claims the Sep. 4, 2001 filing date of the above referenced provisional patent application.

### TECHNICAL FIELD

The present invention is related to distributed computer networks, such as, for example, the Internet and intranet networks. The present invention is also related to data routers and methods and systems thereof. The present invention is also related to methods and systems for exchanging data among nodes contained within distributed computer networks. The present invention is also related to business-to-business, application-to-application and enterprise application integration methods and systems. The present invention is additionally related to electronic business trading networks and methods and systems thereof.

### BACKGROUND OF THE INVENTION

NETWORKS. Packet-based communication networks (i.e., such as the Internet) transfer information between computers and other equipment using a data transmission format known as packetized data. The stream of data from a data source (e.g., a source computer) can be divided into variable or fixed length “chunks” of data (i.e., packets). Each packet has a defined destination address to which network devices (e.g. routers) cooperate to forward the packets from the data source to the appropriate data destination. In many cases, the packets may be relayed through several routers before they reach their destination. Once the packets reach their destination, they are reassembled by the destination to regenerate the stream of data.

Conventional packet-based networks generally utilize a variety of protocols to control data transfer throughout a network. For example, the Internet Protocol (“IP”) defines procedures for routing data through a network. To this end, IP specifies that the data is organized into frames, each of which includes an IP header and associated data. The routers in the network use the information in the IP header to forward the packet through the network. In the IP vernacular, each router-to-router link can be referred to as a “hop”.

Furthermore, the Transmission Control Protocol (“TCP”) defines additional functions, such as, for example, data flow control and reliable data transfer. TCP specifies that the data is organized into segments, each of which includes a TCP header and associated data. TCP specifies that a destination must acknowledge segments that it successfully receives. Thus, after the destination receives a segment that has not been corrupted in transit and all previous packets were received, the destination sends an acknowledgment message to the source. In simplified terms, if the source does not receive an acknowledgment within a predefined period of time, the source retransmits the segment. (There are additional situations in which TCP will initiate a retransmission. Inasmuch as these situations are well known in the art, they will not be discussed in detail here.)

Conventional routers thus route packets to the destination end device by inspecting the relevant fields in the packet header and then forwarding the packet to the router next closer to the destination end device. Routing techniques utilized in conventional routers were developed at a time when both the processing capacity available in the routers and the transmission capacity available between routers (i.e., I/O capacity or network bandwidth) were limited. To cope with such limitations, header formats were standardized to simplify router software and conserve processing capacity in routers; such routing software was stored inside the routers to minimize the required transmission capacity between routers. Today, both processing power and transmission capacity are abundant and inexpensive.

APPLICATIONS. Application software has been typically designed with three basic components—the execution engine, the configuration information and the data acted upon by the execution engine in ways prescribed by the configuration. Typically applications have been designed and implemented as a tightly coupled system of these three components. The data format and structure have been configured as proprietary to any given application. This has also restricted access to the data. For example, customer information stored in a sales order management application is usually not available to another application, such as an accounting software module.

This developed because most of the business application software in existence today—for example financial accounting, inventory management, manufacturing resource planning and order management software—was created by independent companies who designed their products to exist as standalone applications. Such applications are not capable of communicating or sharing logic, let alone data, with other standalone applications without significant modifications to each application. It is very rare for integrated application suites, where multiple application modules supposedly communicate and work in concert to perform the functions of a number of standalone applications, in one enterprise to communicate with those of another enterprise, let alone multiple enterprises. Similarly, such inter-enterprise application communication and sharing is not feasible without significant modifications to application software in the enterprises that need to communicate.

However, there is a growing demand for standalone applications to use information from other standalone applications to create an integrated view of corporate resources or business processes or to eliminate errors or unnecessary process steps. In many industries, this integrated view is central to a new class of products and services or as a major mechanism to reduce data re-entry error and system cost. Thus, a need exists for a method and system, which enable inter-application communication in an efficient manner, without significant modifications and associated expenses.

Furthermore, enterprises have also discovered benefits of lower costs and accelerated decision-making if they can share relevant information and business logic with their customers, partners and suppliers. However that information is now contained within and tightly coupled to these difficult-to-modify applications.

Trading networks that enable inter-business communications (“trading networks”), are complicated by a multitude of independent partners, each with their own standalone applications, unique business document formats, security standards and their own notion of routing logic and business processes.

The Internet and other communications networks provide avenues for communication among people and computers that are being used for a wide variety of commercial transactions, including the buying and selling of goods and services. Many somewhat competitive efforts are underway to facilitate commercial transactions on the Internet. However, with so many competing standards of data formats, the parties to a transaction must agree in advance on the protocols, methods and practices to be utilized, which invariably require changes to each application that supports or interacts within such a transaction.

Commercial processes or applications internal to a particular business, which are not compatible with agreed upon standards, may require substantial reworking in order to successfully integrate with other businesses. As a company commits to one standard or another, the company generally becomes locked-in to a given group of transacting parties, to the exclusion of others. Furthermore, as participants in such a tightly-coupled network upgrade their application software, change their preference or modify their business logic, are acquired, acquire or divest business units, unintended cascading of effects requiring significant maintenance efforts to ensure synchronization and environmental stability are virtually certain.

Based on the foregoing, the present inventors have concluded that a need thus exists for a method and system, which would permit documents to be transformed dynamically and automatically from one particular format to another, either standardized or not, without excessive or any user intervention. In order to address the need for dynamic adjustment to the changes certain to occur in software upgrades, preference changes, mergers, acquisitions and divestitures, a need exists for methods and systems for implementing automatic and dynamic negotiation services. Such regulation services are increasingly becoming necessary for businesses, and include so-called “dynamic handshakes” for automated relationship establishments, security method determinations for authentication, authorization, privacy, etc. over a distributed computer network.

The present inventors also realize that a need for a unique and novel object-oriented routing invention that permits any number of business application software to use information (i.e., data and/or process logic) from one or more applications to create an integrated view of corporate resources or business processes. Additionally, the present inventors have concluded that a need exists for a novel object-oriented routing method and system, which enables inter-enterprise application communication in an efficient manner, without significant modifications and associated expenses.

The present inventors have also concluded that a need exists for an object-oriented routing method and system which facilitates inter-business communications over networks, such as the Internet, so that enterprises may further share information with their customers, partners and suppliers in real-time to make speedy and high quality decisions. The present inventors also recognize that a need exists for a method and system, which permits data to be transformed dynamically and automatically from one particular format to another, without excessive or any user intervention.

Finally, the present inventors have concluded that a need exists for a method and system, which enables automatic and dynamic negotiation services for businesses, including so-called “dynamic handshakes” for automated relationship establishments, security method determinations for authentication, authorization, privacy, etc. over a computer network.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present invention to provide a routing method and system.

It is another aspect of the present invention to provide a method and system for implementing a self-contained module of data with associated processing information (“software methods”) as an object.

It is an additional aspect of the present invention to provide a method and system for performing object-oriented routing utilizing an object router.

The above and other aspects of the present invention can be achieved as is now described. A method and system for routing objects over a distributed computer network is disclosed herein. An object, which comprises a self-contained module of data and associated processing information (i.e., software method or software methods), can be designated and thereafter routed over the distributed computer network utilizing an object router, which can parse the object and apply the software method or software methods contained within the object thereby permitting the object router to be a self-programming network device. “Parsing” is the inspection, examination and subsequent extraction of specific details contained in data or in an object. The object router thus comprises an object-oriented routing method and system.

The object router is generally permitted to construct the object by dynamically downloading the associated processing information corresponding to data received from an external data source. Thereafter, the object may be transmitted to another object router. The data and associated processing information can be routed such that the data and the associated processing information may be utilized by a subsequent object router to continue routing the data and the logic further through the distributed computer network. The subsequent object router can comprise a “next-hop” object router. Additional processing information may be downloaded by an object router upon the processing of explicit or implied instructions embedded in a received object. Thereafter, a new object may be constructed.

The object router can utilize the data and/or the associated processing information embedded in the object to download the other set of associated processing information. Additionally, the object router can utilize the data and/or the associated processing information embedded in the object to download a related set of processing information to dynamically replace the current associated processing information. The associated processing information generally comprises at least one software method. Such a software method is generally present within and associated with the object. The object router can be utilized to route both proprietary data and/or data in any standardized format.

This software method can also be used to describe procedures, for example, for automatic and dynamic negotiation of services for businesses relationship initiation, including so-called “dynamic handshakes” for automated relationship establishments or security method determinations for authentication, authorization, privacy, etc. over a distributed computer network.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrating object derivation scenarios, in accordance with a preferred embodiment of the present invention;

FIG. 2 illustrates a block diagram illustrating header construction, in accordance with a preferred embodiment of the present invention; and

FIG. 3 depicts a block diagram illustrating self-contained XML objects, in accordance with a preferred embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

In the networking art today, routing is a process by which data packages (“packets”) are passed from source computers to destination computers over a network such as the Internet. Intermediate networking devices (“routers”) inspect specific elements of each packet in order to make routing decisions to forward that packet closer to the destination specified in the packet. Conventional “packet” routers utilize resident software to make routing decisions based solely on specific data elements (“fields”) within a well-defined and predetermined portion of a packet known as a “header.” Conventional router software performs routing for a finite number of packet header formats. Such routing philosophy is adequate when the header and packet formats are standardized and there exists a small number of such standards.

In the field of object routing, however, there are a great number of standards for data types and a greater number of proprietary data types. Object-oriented programming defines an “object” as the self-contained module of data and its associated processing details or associated processing information (also known as “software methods”).

A radically new routing method, described herein, in accordance with preferred and alternative embodiments of the present invention, can be referred to as “object-oriented routing” and utilizes objects to make routing decisions and perform other routing functions within an object-oriented router (i.e., “object router”), as opposed to relying on fixed packet headers to performing routing tasks. Object routers thus parse the objects and dynamically apply the software methods (i.e., associated processing information) such as routing algorithms or process flow present in the object(s) on the data contained in the objects. By deriving their software methods or associated processing information from the objects or from related objects, as opposed to conventional routers, which rely on resident software, object routers can program themselves dynamically for any variety of data formats.

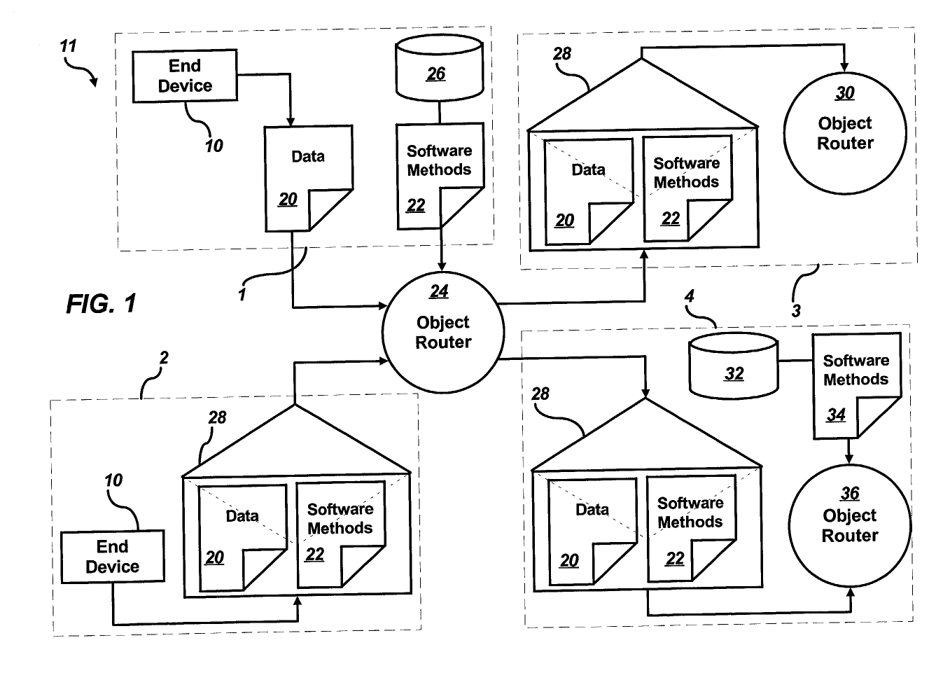

FIG. 1 depicts a block diagram 11 illustrating object derivation scenarios, in accordance with a preferred embodiment of the present invention. FIG. 1 generally illustrates a method and system for routing objects over a distributed computer network, such as, for example, the “Internet” or an “intranet.” An object can thus be designated, which comprises a self-contained module of data and associated processing information. The object can then be routed over the distributed computer network utilizing an object router, which can parse the object and apply the associated processing information contained with the object, thereby permitting the object router to be self-programmed for any data format.

Note that the terms “Internet” and “Intranet” are well known in the art and thus a detailed description of how the Internet functions or an Intranet operates is not necessary. Generally, however, the “Internet” is a worldwide network of networks where the network devices use the IP suite of protocols to communicate with one another. An “Intranet” is essentially a distributed computer network designed for information and data processing within a particular company or organization, and also typically employs applications associated with the Internet, such as, for example, Web pages, e-mail, newsgroups, mailing lists and so forth. Most Intranet-based computer networks are generally accessible only to those within the company or organization.

It is also important to note that as indicated herein, the term “module” may refer to a collection of routines, subroutines and data structures thereof that perform particular tasks or which can implement a particular abstract data type. Thus, a “module” may be configured as a software module. Such a module may comprise at least two portions or functions. First, a module may include an interface, which lists the variables, constants, data types, routines and subroutines that may be accessible by other modules, routines, or subroutines. Second, a module may include an implementation, which is generally private (i.e., accessed only by that module) and which includes a source code that actually may implement the routines, subroutines, and or data types within the module. The term “module” is well known in the art and thus can refer to a software module and/or a self-contained module of data.

As indicated in FIG. 1, four main scenarios 1, 2, 3, and 4 are generally illustrated. These scenarios illustrate how data can be made available in the form of objects to object routers. As indicated by scenario 1, in FIG. 1, an object router 24 can construct an object by dynamically downloading software methods 22 corresponding to received data 20 from an external data source (i.e., end device 10). Software methods 22 may be stored in a database 26 and accessed by object router 24. Note that as utilized herein, the term “software methods” may also refer to “associated processing information” and vice versa.

As depicted in scenario 2 of FIG. 1, end device 10 can construct the object by packaging data 20 and the corresponding software methods 22 and transmitting the object 28 to the object router 24. Note that end device 10 indicated in scenario 2 is analogous to end device 10 illustrated in scenario 1. Note further that in FIG. 1, like parts are indicated by identical reference numerals. Thus, an object can be constructed utilizing end device 10 by packaging data 20 and the associated processing information (i.e., software methods 22) and transmitting the object 28 to object router 24.

As illustrated in scenario 3 of FIG. 1, one object router 24 can route data 20 along with software methods 22 to be utilized by a subsequent object router or next-hop object router (i.e., object router 30) to route the data further downstream. Thus, according to scenario 3 of FIG. 1, data 20 and associated processing information (i.e., software methods 22) can be routed utilizing an object router (i.e., object router 24), such that data 22 and the associated processing information may be utilized by a subsequent object router (i.e., object router 30) to continue routing the data further through a distributed computer network, such as, for example, the “Internet” or an “Intranet”.

As indicated in scenario 4 of FIG. 1, object router 36 can utilize the received object 28 (i.e., data 20 and software methods 22 embedded in object 28) to download another set of software methods 34 to either augment the current software methods (i.e., software methods 22) or replace the current software methods, and thereafter, construct a new object. Note that software methods 34 may be downloaded from a database 32.

Based on the foregoing, it can be appreciated that object routers can derive their routing algorithms from software methods (i.e., associated processing information) present in or associated with the objects, as opposed to conventional routers which rely on resident software to determine the routing algorithm. Utilizing a real-time approach, object routers can program themselves dynamically and can route any data type (i.e., standard or proprietary). The object-oriented routing techniques and associated methods and systems, which are disclosed herein, thus can effectively eliminate the limitations on the number of routing algorithms and consequently the number of standards and packet formats supported by routers.

Additionally, object-oriented routing enables abstraction and separation of routing algorithms from the routing device. In other words, the various routing algorithms that can be utilized by routing devices can be remote (i.e., made available through remote storage or within the objects) to the routing devices. Such a remote configuration enables the creation of so-called “thin” routers that are inexpensive (owing to their simplicity) and very powerful (owing to vast amounts of routing algorithms and intelligence that can be dynamically programmed).

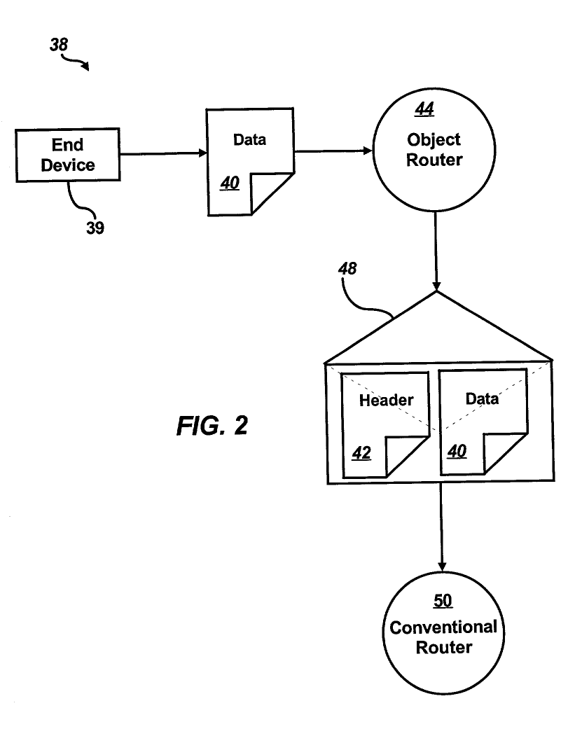

FIG. 2 illustrates a block diagram 38 illustrating header construction, in accordance with a preferred embodiment of the present invention. Conventional routers can route packets only when another device selects the destination end device and identifies the destination by setting the relevant fields in the packet header. An object router 44 can thus be placed between an end device 39 and conventional router 50 that is already in place, thus parsing the raw data (i.e., data 40) sent by end device 39 and make an intelligent determination of the destination end-device. Additionally, object router 44 can construct and add a packet header (i.e., header 42) to the raw data (i.e., data 40) and place the relevant destination information in the packet header. Finally, object router 44 can send the transformed packet (i.e., object 48) to the conventional router 50, which greatly reduces the need to upgrade old devices, such as, for example, batch-processing software to be networked with other devices.

Routing techniques used in conventional routers were developed at a time when processing capacity available in the routers and transmission capacity available between routers (e.g., I/O capacity or network bandwidth) were limited. To cope with such limitations, header formats were standardized to simplify router software and save processing capacity in routers; such routing software was stored inside the routers to save the transmission capacity available between routers. Today, processing power and transmission capacity are abundant. Therefore, the limitations by which conventional routers are constructed are no longer present. Object routers can perform any conventional router function with superior flexibility and cost-effectiveness, as so-called ‘thin’ routers.

In prior art IT (i.e., information technology) environments, data is generally proprietary to a given application. For example, customer information stored in an order management application is typically not available to another application such as the accounting application. However, there is a growing need for applications to use information from each other for integrated view of corporate resources. To address this growing need, corporations modify their applications to use, send and receive data from each other for integrated processing. Since the data exchanged by applications are proprietary, special purpose routing software is required to interpret the data and route it to the appropriate destination application. The object-oriented routing methods and systems disclosed herein can thus be used very effectively to route proprietary data between applications and eliminate the need to modify complex proprietary software to enable interconnected applications.

Inter-business communications over networks such as the Internet is becoming common as enterprises stand to gain handsomely by sharing information with each other in real-time and improving the speed and quality of decisions. Trading networks that enable inter-business communications (“trading networks”), however, are complicated by a multitude of partners, each with their own business document formats and their own notion of routing logic and business processes. Object-oriented routing can be used in a trading network to process business documents flowing among business partners and to enable automated routing and processing decisions relevant to the business document.

In typical business settings, multi-level approval processes are often required for certain decisions, such as, for example, approval of business-related travel, raising capital for expansion through bank-loans and hiring personnel. In these examples, an approval document may be sent to those personnel who need to approve these business needs in a particular predetermined order. In such cases, the document is generally accompanied by a routing slip, which specifies the order in which the document should be routed to the approving persons. The routing slip also specifies the conditions upon which the document is to be routed further down the company “chain” or returned (i.e., rejected at any stage). The object-oriented routing methods and systems disclosed herein can thus enable such approval processes to be automated across a network of approving persons or systems by associating the routing slip and the approval conditions with the document. The approval process automation can be extended to workflow implementations where the operations of multiple disparate systems can be coordinated and synchronized in order to perform business processes.

For example, customer service in the software industry requires coordination and synchronization between customers, value added resellers, technology vendors (for hardware and software trouble-shooting), warranty under-writers, distributors and carriers. Likewise, order fulfillment in online retail requires the customer, retailers, manufacturers, warehouses, credit validation agencies, payment authorities and carriers to be coordinated and synchronized. These examples can be extended to other industries including supply chain management in manufacturing; coordination of providers, insurers, medical professionals and pharmaceutical agencies in healthcare; or coordination of multiple service providers in telecommunications industry to provide an end-user service (such as a high-speed connection to the Internet). In all of the above examples, object-oriented routing enables the workflow routing logic to be embedded in the document(s) that are exchanged by the computing systems and applications that cooperate, both wittingly and unwittingly to execute the workflow.

As well, automatic and dynamic negotiation services can be described in these software methods and made available to an object router. These services, including so-called “dynamic handshakes” for automated information validation, authentication, relationship establishment, security method determination for authorization and privacy, preferred object format definition or definitions and any other detail required to automatically establish inter-business processes between two or more independent business attempting to establish an inter-business relationship over a distributed computer network.

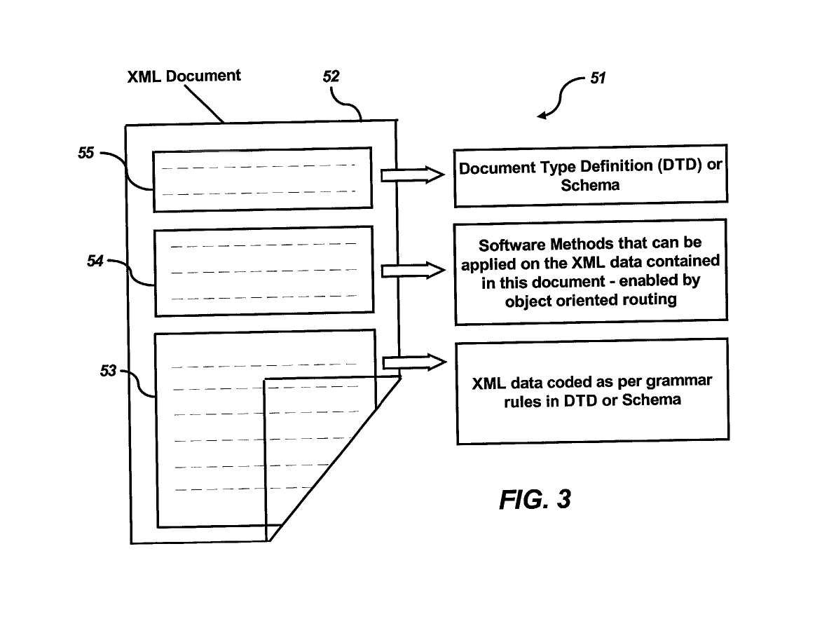

FIG. 3 depicts a block diagram 51 illustrating self-contained XML objects, in accordance with a preferred embodiment of the present invention. In the last 5 years, mark-up languages have become prevalent. Two examples of mark-up languages are Hyper-text Markup Language (HTML) and extensible Markup Language (XML), both derivatives of Standard Generalized Markup Language (SGML). Of the well-known mark-up languages, XML is quickly becoming universally accepted as a standard way to code data structures for data to be exchanged among applications. XML's popularity can be attributed to its ability to contain self-describing data, as illustrated in FIG. 3.

An XML document 52 can contain not only data 53 (i.e., shown at the bottom of XML document 52), but also rules 55 (shown at the top of the XML document in figure) that define the organization of the XML data and the constraints of the values that XML data elements can comprise. Current XML technology permits applications that exchange XML documents to ensure that the document is formed correctly. The interpretation of the XML documents, however, and their data elements for the purpose of computation, decisions, routing and storage are typically found in proprietary software, which is resident inside application software that is separate from the XML document. That is, XML provides no standard technique for two applications in communication to interpret and apply the same business logic to a given XML document.

The “object-oriented routing” technique described in this invention disclosure enables software methods 54 (i.e., shown in the middle of XML document 52) applicable to the XML document content (i.e., DTD/Schema as well as the data) to be specified along with the document. Note that the acronym “DTD” refers generally to “Document Type Definition.” Therefore, the object-oriented routing technique described herein can enable transformation of “self-describing data” to “self-contained data”. Any of the four object derivation scenarios 1-4 illustrated in FIG. 1 can be utilized to derive the software methods that belong to a “self-contained object”.

In a communication environment, the existing method of embedding the software methods inside the receiving application software limits the number of XML document types and the processing logic (computational, decisional, routing and storage) that can be handled by the receiving application to a small set. However, embedding the processing logic within an XML object enable “thin” applications that derive their processing logic from the “objects in motion” and are able to handle unlimited choices of document types and offer unlimited processing logic possibilities.

1. A method for routing objects over a distributed computer network, said method comprising the steps of:
designating an object which comprises a self-contained module of data and associated processing information; and
routing said object over said distributed computer network utilizing an object router, which can parse said object and apply said associated processing information contained within said object, thereby permitting said object router to become self-programmed for varying data formats.

2. The method of claim 1 wherein said object router comprises an object-oriented router.

3. The method of claim 1 further comprising the step of:
permitting said object router to construct said object by dynamically downloading said associated processing information corresponding to data received from an external data source.

4. The method of claim 3 further comprising the step of:
constructing said object utilizing an end device by packaging said data and said associated processing information; and
transmitting said object to said object router.

5. The method of claim 4 further comprising the step of:
routing said data and said associated processing information utilizing an object router, such that said data and said associated processing information may be utilized by a subsequent object router to continue routing said data further through said distributed computer network.

6. The method of claim 5 wherein said subsequent object router comprises a next-hop object router.

7. The method of claim 5 further comprising the step of:
downloading other associated processing information utilizing a received object; and
thereafter constructing a new object.

8. The method of claim 7 wherein said object router can utilize said data or said associated processing information embedded in said object to download said other set of associated processing information.

9. The method of claim 8 wherein said object router can utilize said data or said associated processing information embedded in said object to download said other set of associated processing information to augment current associated processing information.

10. The method of claim 8 wherein said object router can utilize said data or said associated processing information embedded in said object to download said other set of associated processing information to replace said current associated processing information.

11. The method of claim 1 wherein said associated processing information comprises at least one software method.

12. The method of claim 10 wherein said at least one software method is present within said object.

13. The method of claim 10 wherein said at least one software method is associated with said object.

14. The method of claim 1 wherein said object router can route proprietary data.

15. The method of claim 1 wherein said object router can route standard data.

16. The method of claim 1 further comprising the steps of:
permitting said object router to construct said object by dynamically downloading said associated processing information corresponding to data received from an external data source;
constructing said object utilizing an end device by packaging said data and said associated processing information;
transmitting said object to said object router;
routing said data and said associated processing information utilizing an object router, such that said data and said associated processing information may be utilized by a subsequent object router to continue routing said data further through said distributed computer network, wherein said subsequent object router comprises a next-hop object router;
downloading other associated processing information utilizing a received object; and
thereafter constructing a new object.

17. A system for routing objects over a distributed computer network, said system comprising:
module for designating an object which comprises a self-contained module of data and associated processing information; and
module for routing said object over said distributed computer network utilizing an object router, which can parse said object and apply said associated processing information contained within said object, thereby permitting said object router to become self-programmed for varying data formats.

18. The system of claim 17 wherein said object router comprises an object-oriented router.

19. The system of claim 18 wherein said object router is permitted to construct said object by dynamically downloading said associated processing information corresponding to data received from an external data source.

20. The system of claim 19 further comprising:
module for constructing said object utilizing an end device by packaging said data and said associated processing information; and
module for transmitting said object to said object router.

21. The system of claim 20 further comprising:
module for routing said data and said associated processing information utilizing an object router, such that said data and said associated processing information may be utilized by a subsequent object router to continue routing said data further through said distributed computer network.

22. The system of claim 21 wherein said subsequent object router comprises a next-hop object router.

23. The system of claim 21 further comprising:
module for downloading other associated processing information utilizing a received object; and
module for constructing a new object.

24. The system of claim 23 wherein said object router can utilize said data or said associated processing information embedded in said object to download said other set of associated processing information.

25. The system of claim 24 wherein said object router can utilize said data or said associated processing information embedded in said object to download said other set of associated processing information to augment current associated processing information.

26. The system of claim 4 wherein said object router can utilize said data or said associated processing information embedded in said object to download said other set of associated processing information to replace said current associated processing information.

27. The system of claim 17 wherein said associated processing information comprises at least one software method.

28. The system of claim 27 wherein said at least one software method is present within said object.

29. The system of claim 27 wherein said at least one software method is associated with said object.

30. The system of claim 17 wherein said object router can route proprietary data.

31. The system of claim 17 wherein said object router can route standard data.

32. The system of claim 17 further comprising:
module for permitting said object router to construct said object by dynamically downloading said associated processing information corresponding to data received from an external data source;
module for constructing said object utilizing an end device by packaging said data and said associated processing information;
module for transmitting said object to said object router;
module for routing said data and said associated processing information utilizing an object router, such that said data and said associated processing information may be utilized by a subsequent object router to continue routing said data further through said distributed computer network, wherein said subsequent object router comprises a next-hop object router;
module for downloading other associated processing information utilizing a received object; and
module for thereafter constructing a new object.
